(19) United States
(12) Patent Application Publication
(10) Pub. No.: US 2016/0071032 A1
(43) Pub. Date: Mar. 10, 2016

(54) Personnel Resource Management System

(71) Applicant: MANAGEUP PRM, INC., Santa Clara,, CA (US)

(72) Inventor: Gregory Hunter, (US)

(21) Appl. No.: 14/769,981

(22) PCT Filed: Feb. 23, 2014
(86) PCT No.: PCT/US14/17871

§ 371 Date: Aug. 24, 2015

Related U.S. Application Data
(60) Provisional application No. 61/769,094, filed on Feb. 25, 2013.

(51) Int. Cl. G06Q 10/06; G06Q 10/10; G06Q 50/20; H04L 29/08

(52) U.S. Cl. CPC G06Q 10/0631; H04L 67/02; H04L 67/306; G06Q 10/105; G06Q 50/2057; G06Q 10/0633

(57) ABSTRACT

The present invention is in the technical field of personnel management systems and methods for integration and streamlining business operations. More particularly, the present invention is in the technical field of computer, Internet and network based personnel management systems and methods for wherein unique dash boards are implemented to organize and streamline business operations.

### CROSS-REFERENCE TO RELATED APPLICATIONS

This application claims priority of U.S. Provisional Application Ser. No. 61/769,094, filed on Feb. 25, 2013, titled ‘Personnel Resource Management System,’ which application is incorporated in its entirety by reference in this application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of personnel management systems and methods for integration and streamlining business operations. More particularly, the present invention is in the technical field of computer, Internet and network based personnel management systems and methods for wherein unique dash boards are implemented to organize and streamline business operations.

Communication Inefficiencies are a Major Problem for Businesses, Big and Small

In all different industries, companies and sectors, communications between internal and external contacts are critical for the smooth operation of business. Communication inefficiencies can lead to the loss of money, customers, clients, projects, and are often a waste of valuable time and resources of businesses. For example, communication inefficiencies in U.S. hospitals exceed 10 Billion U.S. dollars which contributes to personnel shortages, staff and patient dissatisfaction and medical errors. (Agarwal R, Sands D Z, & Schneider J D. (2010). Quantifying the economic impact of communication inefficiencies in U.S. hospitals. J Healthc Manag. 2010 July-August; 55(4):265-81; discussion 281-1) There is currently a significant need for a more efficient business communication system that not only more effectively provides companies with access to and dissemination of information, but also encourages employees to engage in communications.

Access to Experts is Critical in Rapidly Changing Business Environments

With software advances, technology, changing compliance requirements, and new laws and guidelines, businesses need to rapidly keep up in order to not fall behind the competition. It is essential that businesses stay informed of new laws, regulations and guidelines in order to provide the best quality services efficiently, without any legal issues or financial consequences. For example, the impact of treatment variations and inconsistencies is significant in the healthcare industry. Better quality and safety could save nearly 90,000 lives and as much as $400 billion a year. (Source: www.cbo.gov/ftpdocs/87xx/doc8758/maintext.3.1.shtml)

Unsustainable Pattern of Inflationary Costs

Businesses are confronted with inflationary costs due to rising commodity prices, economic downturn, and many other factors. Today, in the healthcare industry, there exist an increased and unsustainable pattern of inflationary costs due to the technology growth, medical advances, the increased aging population and changing patient income and insurance coverage, which has substantially driven up healthcare costs. In today's economy, wages have been reduced and unemployment rates are high which is contributing to less money in the insurance pool. (Source: www.cbo.gov) Currently, there is a need for a system that will assist businesses in offsetting inflationary costs by providing a cost and time saving approach.

In Current Models, Human Resources are not Utilized as Efficiently as they could be

Currently, human resources departments provide essential support functions to businesses; however, often these resources are not being used efficiently. Departments receive hundreds of e-mails a day, are over staffed or understaffed and often focus efforts on matters that are not the greatest business priorities.

“Human Resources,” as it pertains to the healthcare industry, can be defined as the different kinds of clinical and non-clinical staff responsible for public and individual health intervention. As arguably the most important of the healthcare system inputs, the performance and the benefits the system can deliver depend largely upon the knowledge, skills and motivation of those individuals responsible for delivering health services. Therefore, practices must be developed in order to find a balance of workforce supply and the ability of those practitioners to practice effective and efficiently. (Source: http://www.who.int.proxy.lib.uwo.ca:2048/whr/2000/en/whr00_ch4_en.pdf)

The Prior Art does not Provide an Adequate Solution to the Above Problems

Currently, businesses and organizations are generally being run and managed by individuals and teams. Software has revolutionized every aspect of business. Often teams implement computer based management systems to organize inventory, intake and out take, finance, large databases of information and other features essential to their specific operational needs. Often, such computer based tools assist in the organization or streamline a certain aspect of the business, but fail to organize all aspects of the business into one easy to use system.

Further, conventional computer based personnel management systems, applications and methods allow for task management, creation of projects and communications of personnel within those project teams, but still fail to integrate those projects into a larger scheme of the business as a whole. Other software based personnel management systems focus on communications with customers, organizing and storing all communications, contracts, and related customer information into a database and providing notifications to personnel regarding deadlines and requirements, yet are not integrated into general business operations.

Software has even been used in the healthcare industry to organize medical records, gathering, storing and maintaining all patient data electronically. Further, patented hospital software systems allow easy transfer of medical information, including multimedia data, patient data, and automatic updating task management tools. (See U.S. Pat. Nos. 5,586,262, 6,424,996, 6,434,569, 5,072,383 and 5,924,074).

Newer healthcare systems attempt to cure the problems of inefficiency, by providing a more integrated platform, yet often still fail to provide a fully integrated system. For example, Ingenious Med® provides a software application, which can be used on computerized devices, including mobile devices, to manage physician work flow, charge and data capture, coding and documentation, quality, reporting, communication, mobility, billing and integration, yet fails to integrate features to manage staff personnel work flow and other human resource management.

Other industries also would greatly benefit from an integrated software management system that focuses on the entire business, promoting efficiency, communication, quality, and cost savings. Therefore, there is a need for a more efficient computerized system for businesses to securely track, store and transfer data, communicate, organize all levels of work flow and all departments, while keeping abreast industry updates, training needs and more. Currently, no software system exists that brings together all these features into one simple to use product, until now in the present invention.

### SUMMARY OF THE INVENTION

The present invention is a computerized software system and network platform for businesses, allowing full integration of all business operations. More specifically, the present invention is a software system and network allowing businesses to securely track, store and transfer data, communicate internally and externally, organize all levels of work flow and all departments, scheduling and task management, receive automatic updates of industry specific materials, and access experts for assistance.

The present invention creates a rule and role based system which will train, remind, and strengthen businesses around their processes while creating transparency throughout the organization. Through utilization of unique dash boards, mind maps, communication tools and a role based platform, this personnel relationship management system promotes safety, quality, effectiveness, efficiency and satisfaction, wherein the system is supported by staff and consultants to provide best practices, updates, education and training continually and automatically, as well as upon request. The system combines messaging, e-mail notifications, chat, the ability to share video and photos, blogging, activity streams and other features. Additionally, the system can be uploaded to mobile devices, tablets and nanotechnologies. Features of the system include easy access, user friendly design, customizability and expandability to client needs, continuous support, departments virtual grids stored securely on a Hybrid Cloud where such storage allows the system to be accessed worldwide. In the healthcare industry, the system provides users with best practices, workflows around standards of care, policies, procedures, compliance and regulation templates, performance evaluations and competencies, safety and quality, and effectiveness and efficiency models for analysis.

The central platform of the system is the unique dashboard design. The dashboard contains categories of elements including: (a) communication, notifications and messaging, (b) calendar and scheduling, (c) education and training, (d) application launch pad to launch existing applications, and (e) a transparency graph. Users are supplied with a virtual department grid created by industry leaders. The virtual grid will comprise a preset communication tree for effectiveness, incorporated policy and procedures, training education tools, reliable information for decision making, logistics and technology support.

In the current invention, the dashboard is implemented to aggregate various forms of communication from staffing scheduling conflict, to critical communications that need urgent attention, tasks, changes and information for collaboration. This information will come from all different sources, including e-mail, messaging, task systems, documents depositories and third party resources. The system prioritizes the communications and information for the client, so that employees no longer have to search through hundreds of e-mails a day. Further the system allows for real time feedback for operational matters, staffing, time keeping, payroll, safety and quality issues, as well as employee concerns and feedback. Aggregating and integrating current technologies, to support current products and vendors already utilized in companies, organizes existing technologies, as the cost of exchanging these products would be enormous.

The system can integrate and support current products and vendors already utilized in companies. These applications are housed in the app section of the dashboard. For example, financial information will can be integrated into the payroll system since the login is integrated into the time systems. As companies go through different phases financial and payroll systems can be simulated. Once simulated, the system provides a means through which bonuses, raises and rewards can be integrated into the virtual dashboard and managed. Further, the system will give real-time feedback viewable on the transparency graph regarding a user company's costs relating to staff and performance. The system virtualizes the user's organization and employees by way dashboards, allowing financial integration of the system software, as well as the integration of an existing product or products. Additionally, the system aggregates existing communication technologies of digital voice, short message services (SMS) and e-mail communications from other services, such as Gmail® and Outlook®, integrating them into the system of the present invention by converting the message into a task or adding a topic which is linked to the system's transparency graph.

One embodiment of the system's communications, notifications and messaging component contains a need to know notification screen that will appear once users sign in, displaying all critical communications, and through which staff can call, video, chat or text to other through the aggregated messaging system, which combines all messages into a central location for streamlining communications. In one embodiment of the system, a user cannot proceed without acknowledging notifications and these messages can be converted into tasks.

The calendar feature may provide to all members of the team the ability to manage and preview all critical operational events, and automatically receive regularly updated compliance and training information. Further, this feature may allow for tracking of all licensing, required maintenance and warranties. The system has built in schedule concepts that will build and retain motivation of users using the system's document features, as well as providing staffing models.

The education and training feature allows educational and training materials to be pushed to users. Third parties may provide trainings to support their products, which are supported and accessible through the training module of the system. Managers can direct trainings through the system, to develop more effective staff. Training materials are constantly updated with on going performance and compliance measures. Training materials can be in the form of text, video or audio trainings, tutorials, as well as interactive and fixed educational tools. Users will be orientated to new processes, procedures and organization through use of these trainings, quickly and effectively, saving company time.

The application launch pad portion of the system allows users to launch any existing program through the system. For example, in the healthcare industry, the application launch pad module could access and use electronic medical record software, applications for specific medical devices, billing software, the scheduling interface and other health related technologies already implemented in the hospital setting. In contrast to the prior art, which provides individual systems to make, for example, an electronic medical record software, the software system of the present invention allows for integration of existing technologies into one, central, simplified unit to save time, money and to reduce errors.

The transparency graph feature allows for the linking of critical information in this easy to use graph. In one embodiment, users on a need to know basis will be able to see if other users have completed tasks. For example, a manager can see if his or her employee completed a task assigned, or whether additional resources will be needed to be focused so that the task can be completed within a deadline. In this embodiment, the transparency graph has a bottom up approach. For instance, a company CEO can see if the person four sections over and six levels down on a virtual organizational chart has completed a critical operational ready task, but the person in that position cannot see if the CEO completed his or her tasks. In one embodiment, only high level staff can view the transparency graph to minimize communication clutter to critical operations.

In one embodiment of the present invention, the transparency graph allows pulling of critical information from products and information systems to become data mined into the system's dashboards. From an understanding of the data mined information aggregated into the system dashboard, users can use this information to form relationships with third parties. Data is pulled from various products and information systems into the present system's transparency graph and normalized into a standard format. This will occur by building application programming interfaces and interface connections with these outside products and information systems which will pull/push data and convert information first into a standard format then scaled into the system's transparency graph. Data is then visible, customized, prioritized and customizable on a need to know basis based on the particular employee's role in the organization. Users can then access third parties' products or applications through the system's transparency graph which acts as a single point of role based information aggregation. For example, if a company is using an inventory software, the amount or volume of an item will be seen on the transparency graph. In one embodiment of the present invention, this item will be color coded according to ordering priority. In this example, a color caution could mean that supply is running low and should be ordered. (Everything from order to delivery time will be seen as a user selects this color on the transparency graph.) Another color indication could represent that an item is running critically low or completely out, prompting an express order. (From express order to delivery time will be seen as the user selects this color on the transparency graph.) In this example, the system further integrates existing software, as the user would be able to select the color on the graph and see exactly what needs to be ordered and launch the inventory software the company is currently using. The color on the graph will not return to safe until the ordered item has arrived.

One embodiment of the transparency graph notifies users to the importance of a communication or notification, by implementing attributes, such as color to signify the importance. Users may access the transparency graph by authenticating a primary login. Employees at all layers of the company can view tasks, scheduling, documents and communications, enhancing communications throughout the company. Further, virtual organizational charts used in the system display which employees are at work, in which departments to quickly and efficiently allow other users to know critical information, such as who is available, where available employees are located, which may be implemented through use of global positioning system (GPS), and what expertise and competencies they have. The system provides streamlined operations as all information can be aggregated into one transparency graph.

The present invention contains a virtual management system. The virtual management system offers and collects information on human capital, competencies, organizational diplomacy, deployment and manipulation, organization, planning, pay increases, staffing models, performance analysis, organizational development, scheduling, trouble shooting, leadership training, performance evaluations, compliance training, training and education, individual development planning, building morale, fulfilling the company mission, diversity, strategic communications, bios of personnel, policies and performance objectives. If an employee resigns or retires the system will store a legacy of information around that employee's role which would then be passed on the new hire. The intellectual property of the company remains with the company.

One embodiment of the virtual management system contains an organizational schematic virtual grid of each department, which may be in the form of an organizational chart, containing role based information of all departmental staff. Access to information in the system will be provided to users based on their role within an organization. The system utilizes unique passwords and various rights of use to associate a particular user with a particular role associated with access to or restriction from specific information. For example, only a select few users will be able to change a procedural document or process map based on access granted to users with particular roles, and all other users will be restricted from access since their roles do not authenticate access. The information can display the photo of the employee, contact information, competency information, and links to automatically communicate with the employee through utilization of text, chat, call, video chat, e-mail and other means of communications through the system. The dashboard for the departments contain task based information, work flows (business process management), and documents relevant to those particular individuals.

Pre-template communications are available for use through the system, to save time, create accuracy by reducing human error, and comply with industry standards, as well as allow communications to be tracked through the company. Templates are tailored to the particular roles of individual employees within the company, since employees in different positions would share different types of communications, and require different templates reflecting their specialized needs, standardizing communications. The open and traceable communications through the system, allow employees to quickly and securely communicate ideas and messages to a group of individuals. Additionally, the ability to contribute ideas allows users of the system to get credit for their ideas, and boosts morale and a feeling of being a part of the company, regardless of their position in the company. The system allows for employees to make suggestions and submit ideas to benefit the company, which are stored in the system. The employee will receive a transcript of their contributions from the system, which can lead to bonuses, performance raises, gifts and rewards.

The system also maintains a document repository, which is implemented through the dashboard. For strategic communications, documents behave similar to e-mail through the system, but documents have both subject and category information. Documents from the document repository can be integrated into e-mails and vice versa. When important documentation is necessary to perform a task or communication, employees in the roles associated with that function are alerted through the system. This can also be visualized through the system's saved communications and work flow (business process management) maps. For example, in a hospital setting, from the time a patient enters the hospital until the time the patient is discharged, workflow around that patient would be launched on the system dashboard and easily accessible to doctors, nurses, technicians, hospital administrators, and other hospital staff, yet not stored on the system to protect patient privacy. Additionally, the billing department would receive a notification of any changes and would be provided with the appropriate pre-template forms containing accurate, current information relating to compliance and regulatory policies.

In one embodiment of the present invention, completed documents go to predefined staff, assigned by job roles, and not to particular individuals, keeping information with the job type, rather than with individual people, where information could be misplaced or lost in the event employees change careers. Further, in this embodiment of the invention, documents types are assigned feedback times, during which a responsible party must respond. If the first level is unable to respond, the next layer of responsibility is to respond. As a dead line approaches the transparency graph can provide visual warnings, such as changing colors to alert users that a document is approaching a deadline or overdue. Communications, such as e-mails and messages may also appear to alert everyone who needs to know the document status, deadlines and the potential for a document to be past due. Participants receive merits for using documents in this embodiment, where merits can amount to rewards from employers and/or the company supplying this software invention.

Mind mapping can be implemented through the system, integrated and launched from the dashboard or Process Tab providing visualized workflows of operations and processes. Mind mapping can be integrated into document repository for procedures, policies, competencies, trainings, orientation, and job descriptions, regulations, certificates and more. Task based functionality can be integrated into the transparency graph, e-mail and messaging. Role based maps can be assigned to job types dashboards on a need to know basis.

The system is flexible and adaptable, able to support systems currently implemented in companies. Rather than competing with these technologies, the system forms synergies to enhance the utilization of the systems already in place in companies as well as the new system described in the present invention. An example of the system of the present invention supporting another technology is the integration of a GPS (global positioning system) for the use of EMS (emergency medical services) to manage human resources relating to emergency transportation services and/or other applications and devices such as RFID readers used for the purposes of automatic identification and tracking. For example, these devices would assist in tracking a physician's whereabouts and how much time they spend in and exam room. Information would be displayed on the department schematic on the process workflow tab. The system will offer and/or aggregate a page by way of TAB to incorporate tracking into the system dashboard as one of the system's functionalities.

In addition to all the built in features, the system provides access to consultants who assist the company virtually, specifically customized for the individual needs of each client. Services include best practices, workflows around standards of care, policies, procedures, compliance and regulation templates, performance evaluations, competencies, safety and quality. The system provides the tools to strengthen teams, create a healthy workplace culture, preset communications for effectiveness, provides access to job specific education and training, additional support for existing products and services, as well as real time feedback and transparency.

The specialized consulting team is able to upload information into the virtual cloud to be sent to clients, so users of the system receive this information and updates instantly. Support consultants have specialized skills sets and experience to assist company management and are experts in the different areas and fields of the business clients. These experts can also provide regulatory and compliance support to the system, which automatically updates with the newest rules, guidelines regulations, strategies, billing compliance and other industry procedures. Information is uploaded in categories which are associated with different roles of employees in companies, such that an update would become a priority notice to people in a certain role who need to know the information, whereas, the information may be accessible to other employees through the system, but would not be given critical status. Experts, consultants, support consultants and subject matter experts referenced herein may be defined as a person or entity with a high level of knowledge in a particular skill or subject matter area, or with a high level of expertise in performing a specialized task, job or skill, though one skilled in the art may recognize that other definitions may also apply. Specialized expertise also varies by state, country and region to target the laws and regulations of the user's needs.

Consultants also provide internal questions and answer feedback through the system to users. Users of the system can interact with system experts by submittal of questions using the document features of the system. The document feature for communications that may ultimately be sent to an expert is accessible to all system users, but not all users have direct access to experts through the document feature. Using the document feature allows communication to be transparent and allows all persons to be kept in the loop of information flow.

Although users in certain roles have access to directly contact system experts, such as through calling, the system requests users to also submit a document to encourage and support organizational transparency. Although all system users have access to the document feature of the system, only certain users, designated by the organization based on role, have access to connect with experts through the system. This is achieved by an organization designating certain individuals with access to expert communication document features based on their role within the organization. For example, if a user is struggling with a solution, that user can contact system experts by submitting a document through the system. If the system user is designated by the organization to have access to experts, the document submitted will go directly to system experts. However, if the user is not chosen by the organization to have access to system experts based on the user's role, the document submitted by such a user will first go through an in house chain of command within the organization. Once the document goes through the chain of command, the issue may be resolved internally or the document will be eventually sent to a user or users with access to system experts, based on their role or roles within the organization. If a user receiving the document has access to the system experts based on his or her role, that user may submit the document to an expert through the system. Organizations using the system are encouraged to designate access to system experts to users in high level roles, such as management roles or persons in roles of responsibility of ensuring processes are being followed. Rules and roles are flexible.

Once documents are sent to system experts, experts send communications back to specific users based on their roles established by the organization. Expert advice and consultation can be in the form of documents, or can be directly inserted into or change system features, such as a process map, procedure, policy and/or training material. The documents are populated with the email addresses of those that need to know the information according to their roles.

The system implements SQUEEZE™, which provides resources and documents focused on the concepts of Safety, Quality, Effectiveness, Efficiency and Zest or Client and Staff Satisfaction. If a submittal of a SQUEEZE™ document cannot be answered, the question or concern can be brought to the attention of system experts and experts will act as consultants offering advice. Advice provided by system experts is given to the respective parties to disseminate the communication to the appropriate user(s) using the system messaging, changing a related process map, providing a simulation of that change within their workflow using the process maps, policy, procedure, triggering an on screen notification to users and implementing training materials.

Trainings can be analyzed and measured by managers in real time through the system or viewed later since they are stored. Embodiments of the system include video trainings housed in the system with guides, examples and tutorials that explain the unique features of the system and how to use the system to simplify and maximize use.

The system also allows for management to analyze staff through performance evaluations, which can happen in real time and be stored and saved in the system. If an employee leaves the company, they can receive a copy from the system of a stored transcript of all their contributions, including performance evaluations, real time work, and information on their team effectiveness, suggestions and other information that is not confidential, proprietary, secret or privileged in nature.

The system creates a virtual organization utilizing role based dashboards, providing the basic information for organizational engagement and rules of communication that would not only create a healthy work environment but benefit the organizational objectives. The system recreates the organization, virtually, by incorporating common information such as workflows and basic documents including Policies and Procedures going to market. By virtualizing roles within an organization, the system provides users with the tools to develop these roles and thereby effect communication and delivery of information around content to particular users based on roles.

Housed in a particular dashboard is critical user information, from a user's current status, to departure time, where users have transparent access to information based on their role. Based on a user's particular role, that user is provided with personalized need to know information relevant to his or her position and role within the organization. In one embodiment, each dashboard represents a virtual person within the virtual organization.

Connected to the system dashboards, users can implement the system's virtual business plans (VBPs) and startup models based on their particular role. For example, if a user client wants to open a coffee shop, but does not know what actions should be taken, the user can follow the system's virtual business plans. First, the client user receives dashboards assisting and providing them with information relevant to what actions must be taken to open coffee shop. Therefore, the VBP will provide tasks, time lines, information and resources that would be useful, necessary and relevant to opening a coffee shop. The VBP along with the system and service will walk users step by step through the start up phase what they must do to accomplish goals. The virtual business plan and startup model will walk users through the steps needed to build a business plan or startup phases by following dashboards and organizational charts that will be populated with each employee and basic content that will drive the organizations objectives that joins the organization.

As the client user follows the business plan and is on their way to fulfilling their dream, the system will the support the development of new staff as they are hired. For startups, the system will support the content and resources an entrepreneur may need. The virtual business plan provides users with an interactive checklist from the beginning to end. As a user grows his or her business, system organizational charts and process maps together acts as a role based simulator for the business. The system supports virtualization of a business model complimenting an organization's existing tools and products, and then integrates human assets into this virtual business schematic with the ability of simulating business inputs. The system can simulate business inputs including products, process changes, potential new hires and performance management into this virtual business schematic, thereby supporting the organization's decision making or decision support system and creating a competitive edge. The virtual business plan provides up to date contents delivered to the client users via dashboards. Other dashboards are added through the system as the business grows and more staff is hired.

### BRIEF DESCRIPTION OF THE DRAWINGS

FIG. 1 is a diagram of a preferred embodiment for the information layout of the dashboard feature of present invention;

FIG. 2 is a chart representing an embodiment of the controls of the present invention, including main interface screen elements and definitions;

FIG. 3 is a chart displaying an embodiment of the document repository feature of the system;

FIG. 4 is an organizational chart representing an embodiment of the virtual organizational charts implemented in the present invention;

FIG. 5 is a chart displaying an embodiment of the document process feature of the system;

FIG. 6 is a chart displaying an embodiment of the blog or community space of the system;

FIG. 7 is a flow diagram representing an embodiment of the initial deployment of the present invention to a user;

FIG. 8 is a flow diagram representing an embodiment of the software upgrade process of the present invention; and

FIG. 9 is a diagram representing an embodiment of the system layout of the present invention.

### DETAILED DESCRIPTION OF THE INVENTION

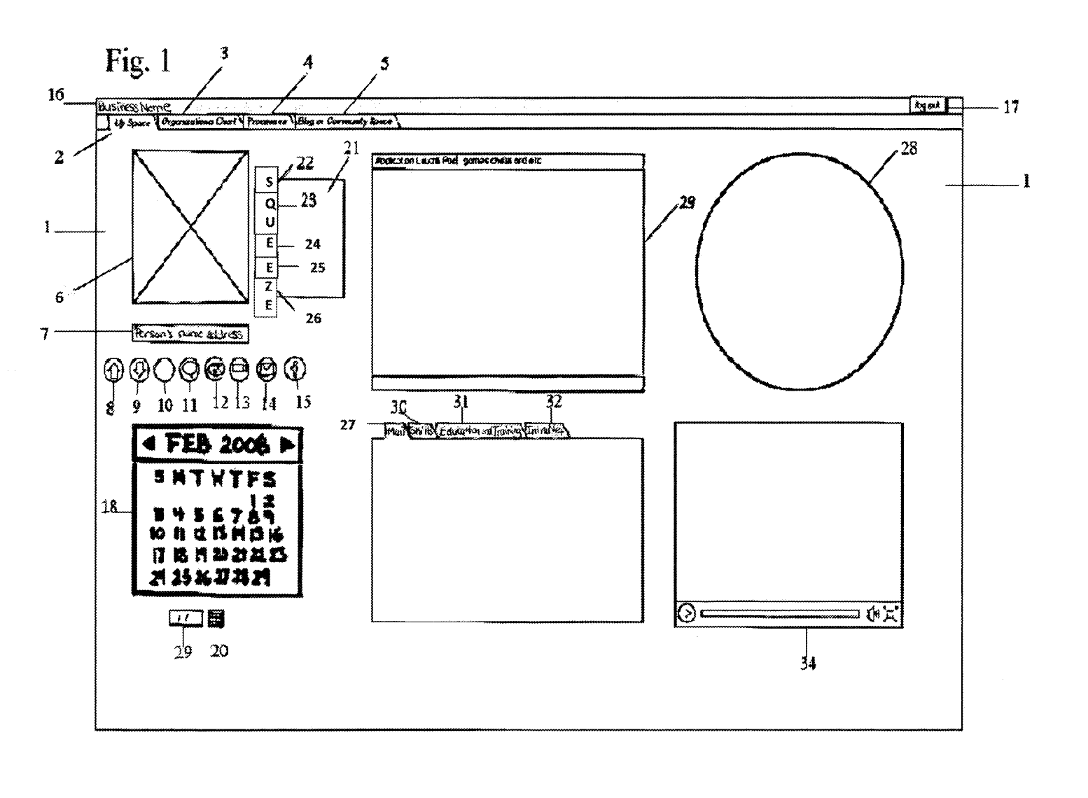

Referring now to the invention in more detail, FIG. 1 shows a diagram of a preferred embodiment of the dashboard feature of the present invention. In the present system, each user will have a unique dashboard 1, where the system provides each user with workflows specific to their role in the organization, role based processes, concepts which will strengthen their purpose in their position, Best Practices, Intranet, communication tools, feedback reporting tools and tools to analyze current resources to increase productivity, communication and efficiency in the workplace, organization or community. In FIG. 1, an embodiment of the interactive dashboard 1 is displayed, on the page referenced by the “Up Space” tab 2. Beyond the home “Up Space” page 2, the system contains an organizational chart 3 page, a processes 4 page and a blog or community space 5 page.

As soon as a user signs in to the system, they will enter the home page 2 and a notification screen will appear for all critical communications and gamification strategies for employment engagement. For example, the user will immediately be alerted to staff that called out, and other important messages from the aggregated messaging system. The user cannot proceed to use the system without acknowledging the notification alert(s). Further, the system can convert messages into tasks displayed within the system itself. Gamification as referenced herein is defined in accordance with the generally accepted definition, summarized and quoted from Wikipedia®: “Gamification techniques strive to leverage people's natural desires for competition, achievement, status, self-expression, altruism, and closure.

A core gamification strategy is rewards for players who accomplish desired tasks. Types of rewards include points, achievement badges or levels, the filling of a progress bar, and providing the user with virtual currency.
Competition is another element of games that can be used in gamification. Making the rewards for accomplishing tasks visible to other players or providing leader boards are ways of encouraging players to compete.
Another approach to gamification is to make existing tasks feel more like games. Some techniques used in this approach include adding meaningful choice, onboarding with a tutorial, increasing challenge, and adding narrative.” Gamification. n.d. In Wikipedia. Retrieved Jan. 26, 2014, from http://en.wikipedia.org/wiki/Gamification

In one embodiment of the invention, notifications would work such that when a user calls out an automated phone tree would be set in motion, contacting all relevant users needing to be notified. A user will be considered relevant based upon his or her role in relation to the role of the user who created the notification alert. For example, when one user calls out, a notification, such as an SMS text could be sent out automatically to contact other relevant users, such as other system users in the same company role as the user calling out, until another person commits to coverage. Additionally, another user with a need to know status role, such as a manager or supervisor will be notified of the communication tree. Therefore, if there is a coverage issue the manager or supervisor would be able to view the issue in the transparency graph, indicated by color, for example.

The dashboard 1 in FIG. 1 is personalized to each user, such that the user's photo, logo or image 6 and personal information 7 will appear on the main page 2. Merits and Badges will also appear. The user has the option to send and receive communications through the system and launch work flow or other documents in the system using the controls and screen elements, wherein indicators display which users are logged in to the system 8, whether they are or are not available when logged in 9, or whether they are not scheduled 10. The system login and log out can provide options for personnel status, such that the user can log if the he or she is going on break, lunch, calling out sick or etc. Other indicators display when messages are received 11, or to use telephone 12, video 13 and e-mail messaging 14 through the system. Social media sites, such as Facebook® and Twitter® can be accessed through the system 15. Further, elements to launch workflow, policies and procedures and documents appear on the main dashboard. In the preferred embodiment the organization, community or business name is displayed 16 on the dashboard, and users can sign out of the system using a log out button 17.

The system calendar 18, coordinates all events of all members of a team, wherein the calendar allows individual users to manage features of their business or organization, including allowing users to manage and preview all Critical Operational events, receive regularly updated compliance and training sessions, receive tracking information of all licensing and warranties, equipment preventative maintenance, schedule concepts that will build and retain motivation, staffing models, and celebrations and anniversaries. All activities scheduled through the system calendar 18, will be viewable to relevant system user members of the workplace, organization or community, such as to all members of a team. Calendar entries can be controlled and searched through the input of a numeric date 19 or through accessing the date in a monthly display 20. Educations and trainings are accessible through the system, and are pushed to users on a need to know basis. This provides many advantages, as it allows third parties to provide trainings to support their products, managers to direct trainings to develop more effective staff, ongoing performance and compliance measures, video training and educational tools, users will be orientated to new processes, procedures and organization, real time performance evaluations, orientations, as well as cultural and organizational development.

The system also implements SQUEEZE™ 21, which provides resources and documents focused on the concepts of Safety 22, Quality 23, Effectives 24, Efficiency 25 and Zest or Client and Staff Satisfaction 26. Participants work through system documents and will be awarded merits and badges for their ideas, solutions, fixes, corrections, and other measurable data, tied to performance and objectives. Criteria may be built by industry specialists and analysts. Merits and badges will be viewable in the system associated with an individual and an organization.

The transparency graph 28 of the system allows users to see all critical information and processes in one location, at a glance, based on roles. Users are able to see if others have completed certain tasks, on a need to know basis, wherein this transparency graph has a hierarchical bottom up approach, such that individuals in positions/roles at a higher level in a company, organization or community can view what tasks and activities are completed by an individual with a lower level position/role in the company, organization or community completed a critical operational ready task. Information contained in the transparency graph 28 is drawn into the system from documents such as processes, procedures, policies, guidelines, work orders, tasks, e-mail, business and strategy analytics, employee objectives and all business functions.

Users are provided with access to a document repository 21 through the system which integrates messaging, tasks and scheduling and is linked to the transparency graph 28, wherein users will use system template documents for inter office communications. To access the document repository, the SQUEEZE™ buttons 22-26 launch the document under the category selected. For example, if the user selects the button “QU,” 23 they would be importing a document type under the Quality category. The Repository 21 will store these communications, and they will be accessible for future evaluation. Users can submit documents through the system, which would go to individuals in various job types for review. Document submittals are prioritized according to urgency, wherein category determines urgency. Promoting responsibility, the digital signature of submitter will live forever on the document. Further, the system can require multiple signoffs, based on job type, for accountability and effectiveness.

Users have access to different applications through the system application launcher 29. Applications can be downloaded through the system, similar to Apps for the iPHONE® and Android®. Applications through the system are secure. Through use of applications, the system aggregates and integrates current technologies being implemented by the company, to support current products and vendors already utilized in companies. The system therefore organizes existing technologies into one central location, saving companies money and resources. Applications are housed in the app section of the dashboard. The application section also can launch system generated applications, and is not limited to outside technologies.

The system provides a users intranet 32 where users can access important information, including electronic mail 27, skills 30, education and training 31 and general company, organization or community information through the intranet 32. Information in the Intranet in the skills 30 section is distributed to promote growth and development targeted specifically for each job type provided by outside experts supporting the system and leaders within the organization, company or community. Weather, news and maps can also be located through use of the Intranet 32 feature. Education and training 31 features education and training videos, tutorials, organizational information related to the company or organization and other information on a need to know hierarchical basis, based on user defined roles.

Implementing the system's video, audio and image feed 34, allows users to engage in trainings, educating, obtain information and view demonstrations. The system is built to provide multiple methods of information retrieval, since people often learn and retain information better through visual or audio than through reading.

The dashboard, is role based, containing information relevant to a particular user dependent upon the user's role in the organization. Further, through the role based system dashboards, users can implement the system's virtual business plans (VBPs) and startup models based on their particular role. The dashboard acts as an information delivery system, with the same transparent features. Links and content, such as words documents, spread sheets and process maps, are provided for business phase development. The content and links can connect users to information beyond system documents. The system provides role based dashboards with templates, processes, spreadsheets, checklist, step by step to do's, logistics and financials. Although the system allows users to access other documents, content and software, the means through which users visualize processes and basic resources and content is supplied by the system. The present invention arrogates and optimizes workflow, processes, while harvesting and simulating best practice models by its characteristics. Once this virtual business schematic is created, human subjects are integrated into the system.

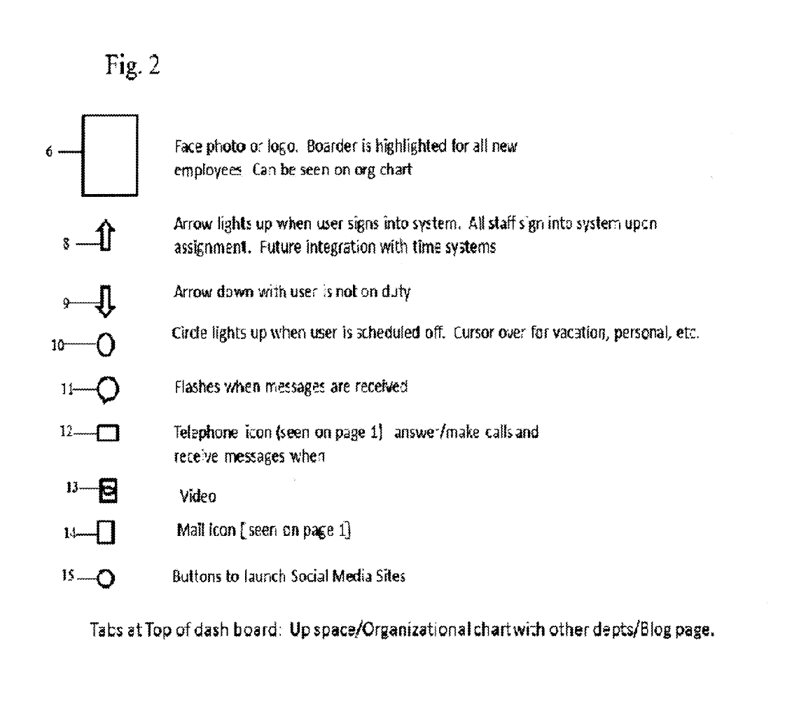

FIG. 2 defines the main interface screen elements and controls. The user has the option to send and receive communications through the system and launch work flow or other documents in the system using the controls and screen elements. An image 6, such as a photo of a user's face or logo is used to personalize the system for a particular user and appears on the welcome page and organizational chart. Indicators 8 and 9 display which users are logged in to the system and whether they are 8 or are not available 9. In the preferred embodiment of the present invention, an up arrow indicator 8 lights up when the user signs in to the system and all staff should sign into system upon assignment. The status of user availability is integrated with time features of the system. In the preferred embodiment, the down arrow indicator 9 indicates that the user is not on duty. Further in the preferred embodiment an indicator circle 10 lights up when a user is scheduled off, and the reason for the absence, such as a vacation, holiday, sick day, or personal reason is revealed by rolling a cursor over this indicator. A word bubble indicator 11 flashes when messages are received. Further, indicators correlate to telephone 12, video 13 and mail 14, and users can view if they have received any of these types of communications or can initiate these forms of communications with other users of the system. Further, social media sites, such as Facebook® and Twitter® can be accessed through the system by the use of social media buttons 15.

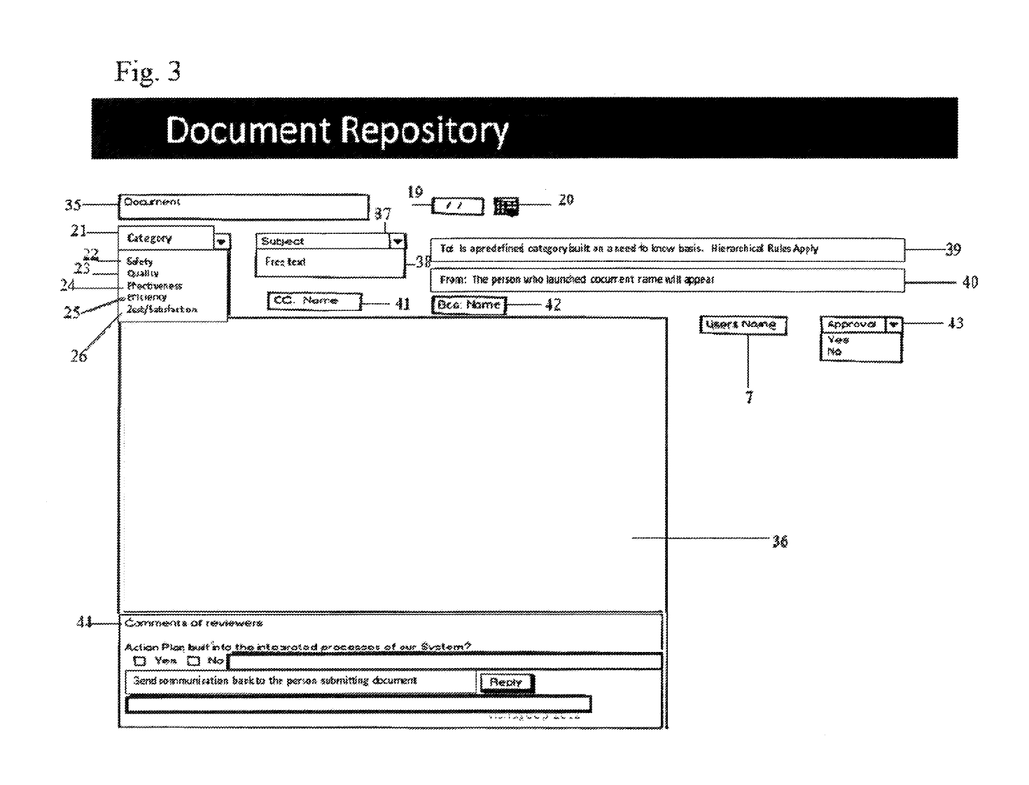

FIG. 3 displays an embodiment of the document repository search features accessible through the SQUEEZE™ feature 21 of the system which integrates messaging, e-mail, tasks and scheduling 19-20 and is linked to the transparency graph, wherein users will gain access to system template documents for inter office communications. To launch a document, the user must access the document menu 35. The document menu 35 is a dropdown menu for SQUEEZE™ documents and others types of documents added by the business client user. To access the document repository, the SQUEEZE™ category dropdown menu 21 launch the document under the category selected associated with the concepts of Safety 22, Quality 23, Effectiveness 24, Efficiency 25 and Zest or Client and Staff Satisfaction 26. Once a particular document is selected in the dropdown menu, the text of the document will appear 36. Subject lines can be selected from a menu 37 or entered as free text 38. Predefined role-based categories of users are built into the system's recipient list 39 based on a need to know basis. The sender's information 40 will correspond to the user who launched the document through SQUEEZE™ and will be displayed 7 on the document repository page. Documents can be carbon copied 41 or blind carbon copied 42 to additional users. The Repository 21 will store these communications, and they will be accessible for future evaluation. Users can submit documents through the system, which would go to individuals in various job types for review. Document submittals are prioritized according to urgency, wherein category determines urgency. Promoting responsibility, the digital signature of submitter will live forever on the document. Further, the system can require multiple signoffs or approvals 43, based on job type, for accountability and effectiveness. This signoff and approval feature 43 allows users to approve or deny approval of the document submission. Further, reviewer users can add comments 44 to the document, including replying to the person submitting the document.

Merits and badges are given based on the SQUEEZE™ 21 category selected and important criteria relevant to the business type. Criteria is built out by industry specialist and analysts, system administrators, experts and consultants. Merits and badges may also be awarded by higher level users to lower level users, but rules will apply and be transparent to all, minimizing favoritism. The merits and badges are part of a greater incentive program the system offers participants, to encourage team work, innovation, communication and collaboration of users. Participants will work through the system document feature to potentially be awarded merits and badges for their ideas, solutions, fixes, corrections, and other measurable actions tied to performance and objectives. Merits and badges awarded to participants will be stored in the system and stay with the organization. Another example of how awards will be distributed is that lead users will be placed on a “Wall of Diligence” to commemorate their achievements.

Category 21 and subject 37 fields are prioritized, such that most critical issues, messages, communications, documents, trainings and information identified via category 21 or subject 37 will be displayed more prominently to the users. For example, if a user in a production factory selects a category 21, “Safety” and subject 37 “broken wing nut,” this message will be given priority since a wing nut is critical in operating the wheel for production, and accordingly this issue would be assigned a short response time, such as a two hour response time. Further, in this example, all persons assigned to this group should respond to the notification. Notifications will be sent via text message, e-mails, and notification alerts will be viewable upon sign on and on the transparency graph. Urgent notifications as these can be pre-assigned to selected individuals for urgent response, including the business owner or CEO. The most important notifications will appear first or more prominently. The system is intelligent and personalized, so that different users will receive different notifications depending on their position/role, and notifications will be given different priority status among different users, depending on the relevance of the message to their position.

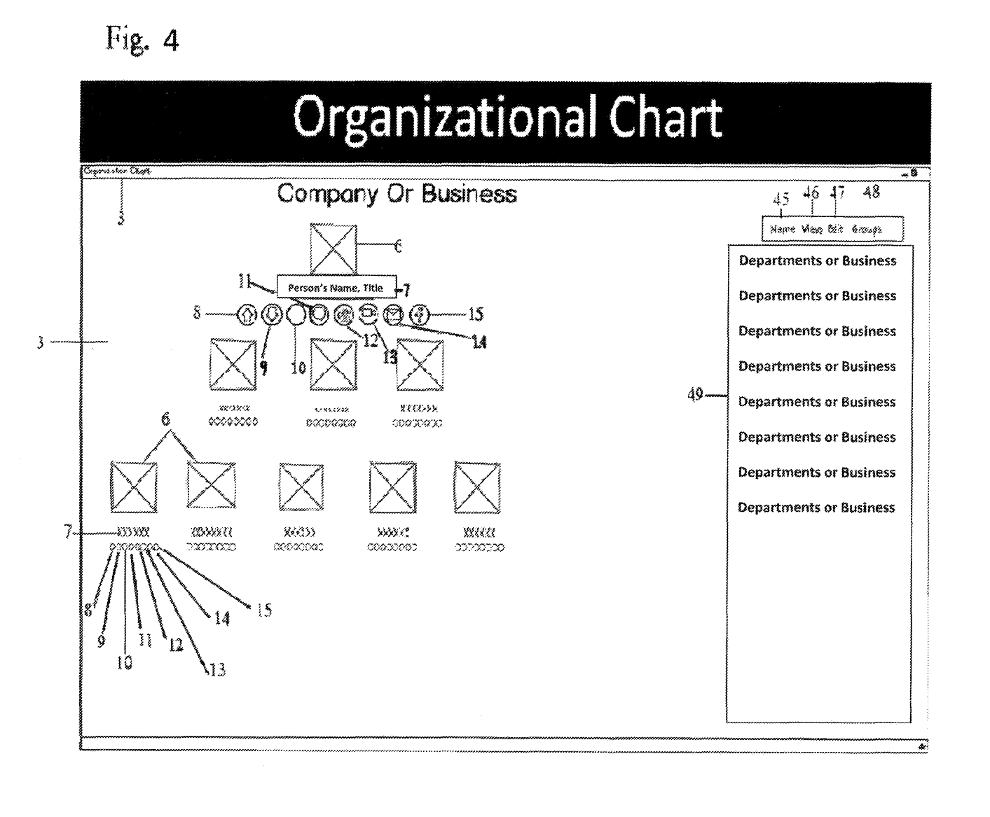

FIG. 4 displays a preferred embodiment of the virtual organizational charts implemented in the present invention to organize people, tasks, and communications of users in the system. This chart is accessed by users of the system through the organizational chart 3 page, and the company or business name 16 may be displayed on the chart.

System organizational charts are personalized to each user, and display a chart of relevant positions to the individual user, showing relevant parts of the structure of the organization and the relationships and relative ranks of its parts, positions and jobs. As in FIG. 4 the user's photo, logo or image 6 and personal information 7 will appear on the organizational chart, along with the photo, logo or image 6 and personal information 7 of other users in related positions, organized by relationships and relative ranks. Merits and Badges may also appear in the organizational chart associated with individual users, along with other competency information. A virtual grid of each department, in the form of an organizational chart, containing role based information of all departmental staff can be used to organize businesses for tasks, scheduling and overall efficiency.

The organizational chart 3 displays contact information, and links to automatically communicate with other users through utilization of text, chat, call 12, video chat 13, e-mail 14 and other means of communications through the system. Users have the option to send and receive communications through the organizational chart 3 of the system and launch work flow or other documents in the system using the controls and screen elements associated with different users on the organizational chart, wherein indicators display which users are logged in to the system 8, whether they are or are not available when logged in 9, or whether they are not scheduled 10. Other indicators display when messages are received 11, or can be accessed to communicate to others users via telephone 12, video 13 and e-mail messaging 14 through the system. Social media sites, such as Facebook® and Twitter® can also be accessed through the system 15. A user can access an indicator by clicking on the icon button below a particular user's name to initiate communication or view information of that user. For example, if one user clicks on the telephone icon 12 of another user, the first user will call the second user through the system. Further, the icons will provide information, such as by changing color or blinking to indicate that the second user should click on the telephone button 12 to receive the call. For example, a phone button 12 could change color or blink to indicate to the user that he or she has a phone message, or is receiving a phone call.

The system also has tools 49 to organize different users into groups to create efficiency in the workplace, as members of these groups will all receive notifications relevant to particular tasks, education and trainings and other critical information. Groups can be sorted, added to, edited, and formed by using different tools including, for example, “Name”45, “View” 46, “Edit” 47, and “Groups” 48, displayed in FIG. 4.

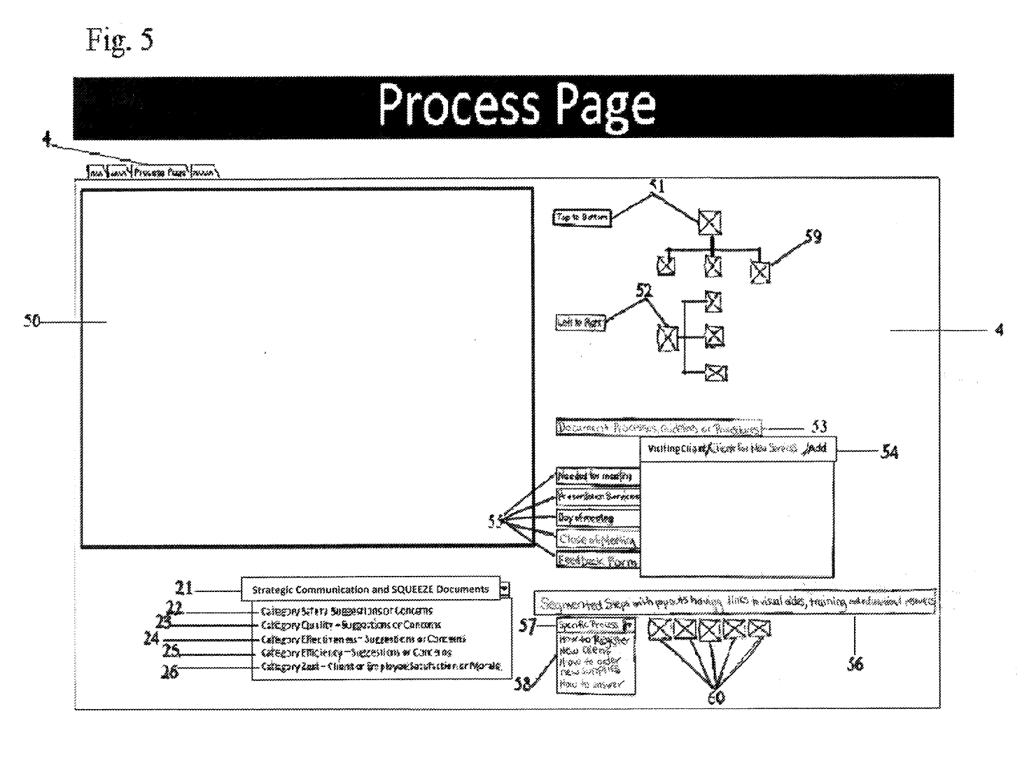

An embodiment of the document process page 4 is displayed in FIG. 5. The process page regulates processes, and guidelines and policies critical to the business or organization. Business process and workflow maps will be available to users on a need to know basis based on the user's role in the system. The system's team of experts will build the processes out for each user based on criteria including business type, which the user organization or business can customize to their needs. The team of experts and consultants supplied through the system will supply industry and best practices information to the organization through the system. These processes can be displayed in various ways including, top to bottom 51, left to right 52, right to left, Gantt, outline and etc., wherein different elements of the process are broken out 59 to facilitate following guidelines, procedures and processes step by step. Many of the processes are task based and link to the transparency graph on the dashboard on the home page. Changes that would effect a process would show up as a notification on the transparency graph. When a process is updated, for example, a user may notice an indicator, such as a color change on the process map. The process map can also be associated with trainings and educations. Maps will have associations with video, audio, documents, messaging, e-mail, calendar and tasks.

Although the layout of the process page 4 will vary from FIG. 5, a key feature is the document processes, guidelines and procedures 53 feature, which can be accessed for example, by a visiting client or new client for services 54. When a user accesses the document processes, guidelines and procedures 53 feature, they can monitor and review critical information related to the process 55, including what is needed for a meeting, presentation services, calendar events such as the date of the meeting, the close of the meeting and can even access feedback forms to add comments. Additionally, the process tab will allow for process simulation for changes in management which should be done prior to rolling out any new process or workflow.

The system process page also implements SQUEEZE™ 21, which provides resources and documents focused on the concepts of Safety 22, Quality 23, Effectives 24, Efficiency 25 and Zest or Client and Staff Satisfaction 26. SQUEEZE™ integrates all users to improve the quality of processes by identifying and removing the causes of errors, variances and variability without specific training in doing so. Through SQUEEZE™ users become contributors while becoming experts by accumulating points within the categories of Safety, Quality, Effectiveness, Efficiency, and Satisfaction or Zest. User contributions will be seen by all, since the system provides increased transparency. The users name and points under these categories will remain with company even after the employee retires or leaves the institution. The system will also offer a transcript of their service under this business management strategy according each SQUEEZE™ Topic.

Segmented steps with pop outs having links to visual aids, training and education resources 56 facilitate users understanding of the processes by receiving more information in different formats to assist in following procedures and guidelines. Users will have access to a drop down menu for specific processes 57 related to the organization, including multiple options 58, such as how to register, new client, how to order new supplies, how to answer and etc. Users can chose an option 58 and pop outs 60 will become accessible.

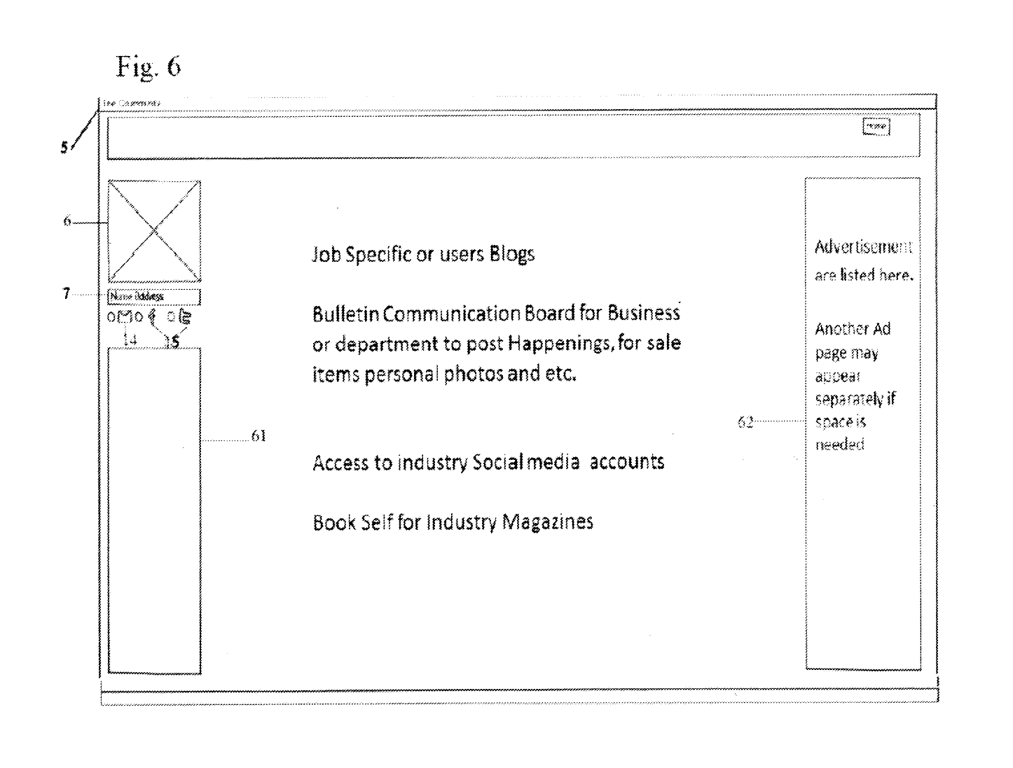

FIG. 6 displays an embodiment of a blog or community space 5 that is provided to users through the system. For businesses and companies the blog can be job specific, for communities, it is community specific. The blog page 5 is personalized to each user, such that the user's photo, logo or image 6 and personal information 7 will appear on the blog page, along with access to e-mail 14, and social networking sites 15, such as Facebook® and Twitter®. Users will have access to industry social media accounts through the blog or community space page 5, which will also act as a virtual book shelf for industry specific magazines and articles. A blog 61 is available for businesses, organizations and community users to post events related to business or for users to communicate about personal matters, such as photos or items for sale. The blog or community space page 5 may have advertisements 62 for system revenue.

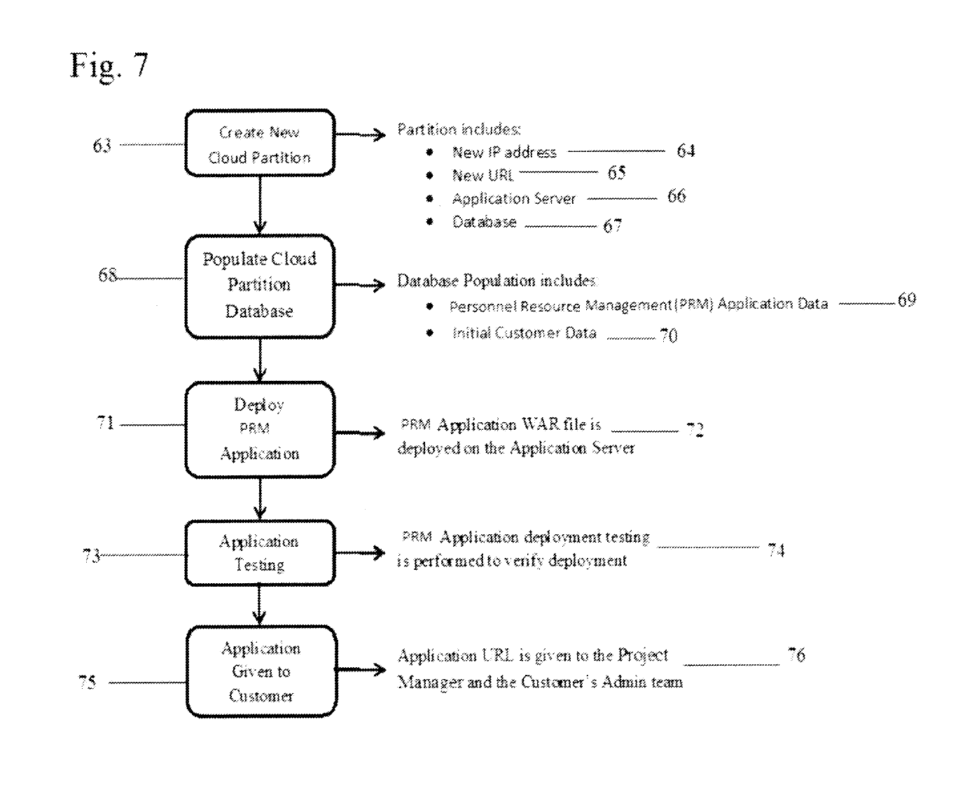

FIG. 7 describes the method of the initial deployment of the computer system to a user. First, a new cloud partition is created 63, including a new client IP address 64, a new client URL 65, an application server 66 and a client database 67. Once the new cloud partition is created 63, the cloud partition database is populated 68 with PRM (Personnel Resource Management) system application data 69 and initial customer data 70. The PRM application is deployed 71, wherein a system file is deployed 72 on the application server 66. Then the system undergoes application testing 73, to verify deployment 74. Once the application deployment is verified 74, the application is provided to the customer user 75, wherein the application URL 65 is provided to the project manager and the customer's administration team 76.

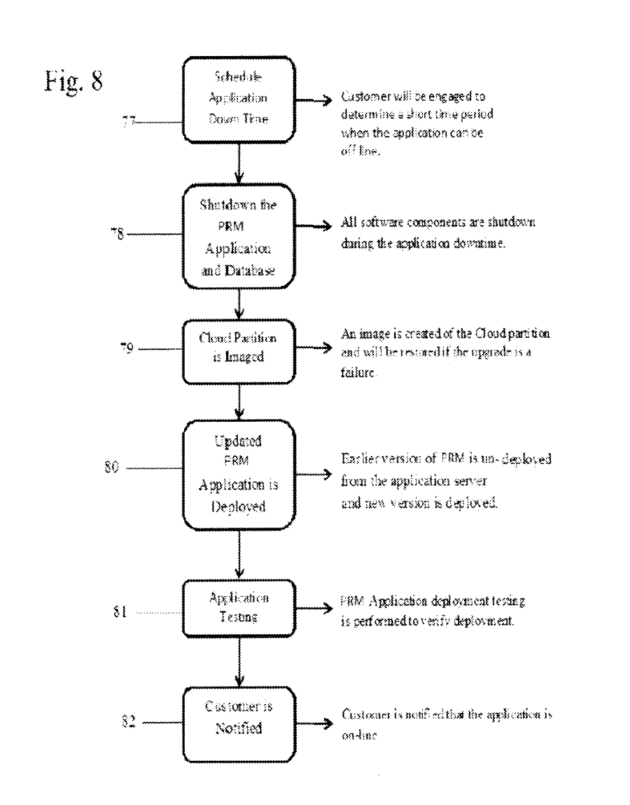

The upgrade process of the software of the present invention is disclosed in FIG. 8. First, the system schedules application downtime 77, where the customer is engaged to determine a short time period when the application can be off line. Once a time is set, the PRM Application and Databases are shutdown 78, including all software components. The cloud partition is imaged 79, wherein the image is created and will be restored if the upgrade is a failure. Once the cloud partition is backed up through being imaged 79, the updated PRM application is deployed 80 and the earlier version of the system is un-deployed from the application server and the new updated version is deployed. After deployment 80, the system undergoes application testing 81, to verify deployment. If this is successful, the application is placed back online and the customer is notified 82.

The current system can be implemented on a web based server or a hybrid web based server. A hybrid web based server referenced herein may be defined as a server that stores some information locally and stores other information on the web hosted on a foreign server, though one skilled in the art may recognize that other definitions may also apply. One reason a company may prefer to use a hybrid server is to safeguard against compromising information access by keeping sensitive information stored locally. Some cloud storage companies will store one company's information on several servers for security reasons.

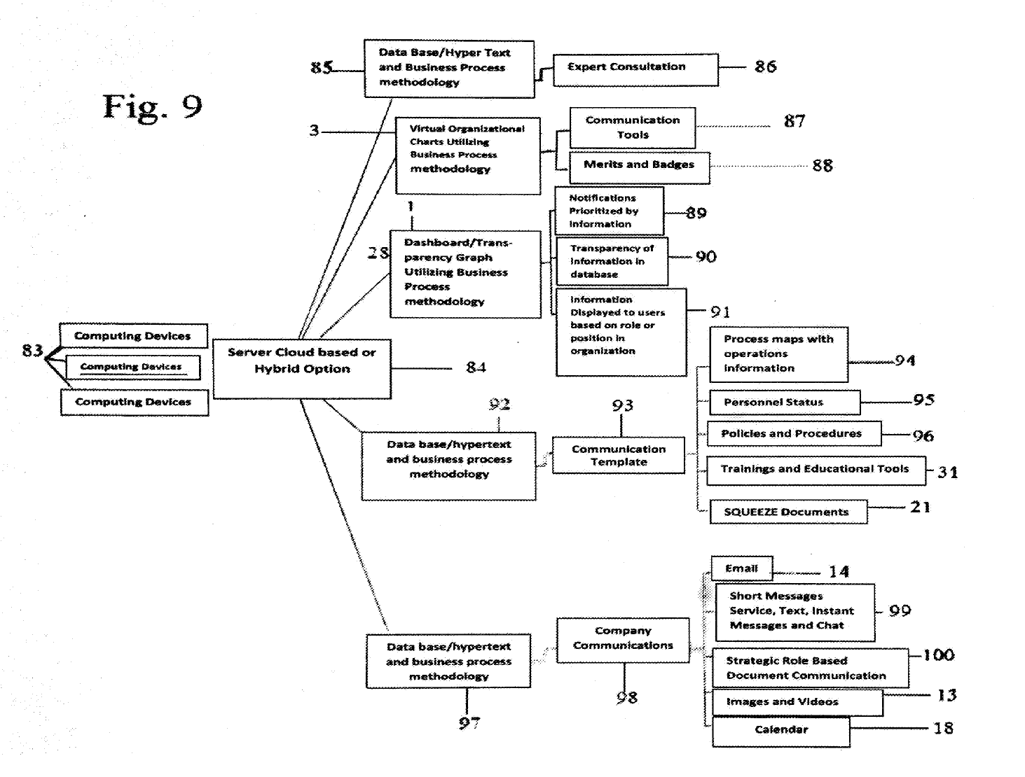

FIG. 9 is a diagram representing an embodiment of the system layout of the present invention. FIG. 9 displays multiple computing devices 83 connecting to the cloud based server or hybrid server 84. The cloud or hybrid server 84 connects to a database hyper text and business process methodology 85 comprising expert consultations 86. The cloud or hybrid server 84 also connects to virtual organizational charts 3 utilizing business process methodology. System organizational charts 3 include communication tools 87 for users to communicate to other users through use of chat, e-mail, text, video, pictures and social media accessible through the organizational chart schematic. The organizational charts 3 also allow for users to grant and display merits and badges 88. Users will be awarded merits and badges 88 for their ideas, solutions, fixes, corrections, and other measurable data, tied to performance and objectives. Criteria to determine merits and badges 88 can be built by industry specialists and analysts. Merits and badges 88 will be viewable in the system organizational chart 3.

The system server 84 connects to the system dashboard 1 containing the transparency graph 28 utilizing business process methodology, where users receive notifications prioritized by importance of information 89, transparency of relevant information in the database 90 to the user and information is displayed to users based on the user's role or position in the organization 91. The system will restrict access to role based information by processing the unique password for each user and various rights of use for each user associated with the user's assigned role within the system. For example, only users in a certain supervisory role will be able to change a procedural document or process map. The system server 84, further connects the data base hypertext and business process methodology 92 to communication templates 93. The communication templates 93 include process maps with operational information 94, personnel status 95, policies and procedures 96, training and educational tools 31, and SQUEEZE™ (safety, quality, effectiveness, efficiency, satisfaction/zest) documents 21. The system server 84, further connects the data base hypertext and business process methodology 97 to company communications 98 including, but not limited to e-mails 14, short message services (SMS), text, instant messaging and chat 99, strategic role based document communications 100, images and video 13 and calendar 18.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The invention is claimed as follows:

1. A method of personnel resource management comprising:
(a) receiving, by one or more computing devices (83), industry specific information in the form of expert consultation services (86) for the purpose of improving safety (22), quality (23), effectiveness (24), efficiency (25) and satisfaction (26) for organizations, employers, personnel, and their clients and members,
(b) storing information received by said computing device(s) (83) in a database (85, 92, 97), which users can access through a web based server (84) product that arrogates organizational information and allows users to access information based on business functions, operations (94) and trainings (31),
(c) providing a rule and role based platform for assignment of user roles based on position (91), such that user access to said information is granted in a hierarchical way (89) relevant to user position in an organization, company or community based on said user's assigned role (91),
(d) prioritizing functions and communications (89) so users receive most critical information first,
(e) generating and storing in a database (92) a document repository (21) of predefined communication template documents (93) for communications within said organization, company or community,
(f) providing users access to communicate and transmit data with one another through the server (84) on said computing device(s) (83),
(g) providing users the ability to perform real time performance evaluations and a venue to contribute ideas to other members of their teams and management, and
(h) providing users access to system applications (29) that allow integration of new system created and existing products from other vendors.

2. The method of claim 1 further comprising hosting information on cloud and local servers (84).

3. The method of claim 1 further comprising imputing information into virtual organizational charts (3) of users within said server (84), incorporating in policy and procedures (96), training education tools (31), reliable information for decision making, logistics and technology support.

4. The method of claim 1 further comprising delivering information in dashboards (1) aggregating and displaying information, notifications and communications in a central location and delivering information through applications (29), wherein transparency of the status of personnel (95), assets, and resources are immediately accessible via said dashboards (1).

5. The method of claim 1, further comprising providing users with a transparency graph (28), allowing a quick view representation of workflow activities, tasks, data, government compliance, and information in one centralized location, wherein system software, and information and software of one or more existing product(s) (29) are integrated into said transparency graph (28), including the integration of and/or linkage of existing communication technologies of digital voice, short message services (SMS) (99) and e-mail communications (27) from other services, documents, videos (13) and electronic medical records (EMR) into said system by converting the information into a task or adding a topic which is linked to said system's transparency graph (28).

6. The method of claim 5 further comprising, interfacing connections with outside products and information systems which will pull/push data and convert information first into a standard format then scaled into said system's transparency graph (28), wherein said information is then visible, customized, prioritized (89) and customizable on a need to know basis based on the particular user's role in the organization (91) and wherein users can then access third party products or applications (29) through said system's transparency graph (28) which acts as a single point of role based information aggregation.

7. The method of claim 1, further comprising providing users the ability to send and receive real time feedback for operational matters (94), staffing, time keeping, payroll, safety (22) and quality (23) issues, performance and competency issues, and providing a venue for employee users to express concerns and provide feedback, wherein said venue allows for employees to make suggestions and submit ideas to benefit the company, which are stored in the system and said submitting employee will receive a transcript of his or her contributions from the system, which can lead to bonuses, performance raises, gifts and rewards (88).

8. The method of claim 1, further comprising providing users with a calendar feature (18) wherein all members of a team are granted the ability to manage and preview all critical operational events (94), and automatically receive regularly updated compliance and training information (31).

9. The method of claim 1, further comprising providing user access to said document repository (21), wherein completed documents are sent to predefined staff (39), assigned by job roles (100), keeping information with the job type and wherein documents types are assigned feedback times, during which a responsible party must respond, and the system will alert the next layer of responsibility to respond if the first level is unable to respond.

10. The method of claim 1, further comprising storing information received by said computing device(s) (83) in a database (85, 92, 97), wherein said information comprises a legacy of information stored around an employee's role such that the information remains stored and accessible to any individual assigned to said role (100).

11. The method of claim 1, further comprising storing information received by said computing device(s) (83) in a database (85, 92, 97), wherein said information comprises information on human capital (95), competencies, organizational diplomacy, deployment and manipulation, organization, planning, pay increases, staffing models, performance analysis, organizational development, scheduling (18), trouble shooting, leadership training, performance evaluations, compliance training, training and education (31), individual development planning, building morale, fulfilling the company mission, diversity, strategic communications, bios of personnel, policies and performance objectives (96).

12. The method of claim 1, further comprising providing users access to communications (98) in various forms, including e-mail (27), digital (99), voice and video (13), to specific individual(s) or role(s) which can be launched directly from organizational charts (3) and from scheduling modules (18).

13. The method of claim 1, further comprising providing a platform that allows for customizability and expandability to client needs, as well as continuous support wherein the system is supported by staff and consultants (86) to provide best practices, updates, education and training (31) continually and automatically, as well as upon request.

14. The method of claim 1, further comprising providing gamification strategies for employment engagement to accomplish continuous process and workflow improvement, wherein through SQUEEZE™ (21) users become contributors while becoming experts by accumulating points within the categories of Safety (22), Quality (23), Effectiveness (24), Efficiency (25), and Satisfaction or Zest (26), such that user contributions will be seen by all, users receive merits (88) for using documents such that merits (88) can amount to rewards from employers and/or the company supplying software, and providing a means through which bonuses, raises and rewards can be integrated into virtual dashboards (1) and managed.

15. A computer-based data processing system for delivering consultation services (86) and personnel resource management improving safety (22), quality (23), effectiveness (24), efficiency (25) and satisfaction (26), the system comprising:
(a) a server (84), that arrogates organizational information and allows users to access information in a hierarchical way (89) based on a user's assigned role in an organization associated with said user's position (91) and in relation to business functions, operations (94) and trainings (31),
(b) one or more user computing devices (83) adapted for connection to said server (84),
(c) a database (92) storing a document repository (21) of predefined communication template documents (93) for communications within an organization, company or community,
(d) said database (92) or an additional database (85) storing industry specific consultation information, received by experts (86),
(e) said database(s) (85, 92) or an additional database (97) storing all company communications (98), including real time performance evaluations, contributions made by users, e-mails (14), texts (99), short message services (SMS) (99) and documents (100) and messages sent,
(f) web based virtual organizational charts (3) of users within said server (84), incorporating in operations (94), policy and procedures (96), guidelines, work instructions, check lists, training education tools (31), communication tools (87), and personnel status information (95), and
(g) web based dashboards (1) aggregating and displaying information, notifications and communications in a central location, granting access to different levels of information, based on said user's position (91) within said organization, company or community, in a hierarchical way (89).

16. The system of claim 15, further comprising a software program collecting critical information from third party's products and data mining collected information into said system dashboards (1).

17. The system of claim 15 wherein said server (84) is a web based server (84).

18. The system of claim 15 wherein said server (84) is a hybrid web based server (84).

19. The system of claim 15, further comprising a virtual transparency graph (28), allowing a quick view representation of workflow activities, tasks, data, government compliance, and information in one centralized location, wherein system software, and information and software of one or more existing product(s) are integrated into said transparency graph (28), including the integration of and/or linkage of existing communication technologies of digital voice, short message services (SMS) (99) and e-mail communications (27) from other services, documents (100), videos (13) and electronic medical records (EMR) into said system by converting the information into a task or adding a topic which is linked to said system's transparency graph (28).

20. The system of claim 15, further comprising software designed to allow users to send and receive real time feedback for operational matters (94), staffing, time keeping, payroll, safety (22) and quality (23) issues, performance and competency issues, and providing a venue for employee users to express concerns and provide feedback, wherein said venue allows for employees to make suggestions and submit ideas to benefit the company, which are stored in the system and said submitting employee will receive a transcript of his or her contributions from the system, which can lead to bonuses, performance raises, gifts and rewards (88).

21. The system of claim 15, further comprising a virtual calendar feature (18) which automatically coordinates all events of all members of a team, wherein said calendar (18) allows individual users to manage features of their business or organization, including allowing users to manage and preview all Critical Operational events (94), receive regularly updated compliance and training (31) sessions, receive tracking information of all licensing and warranties, equipment preventative maintenance, schedule concepts that will build and retain motivation, staffing models, celebrations and anniversaries.

22. The system of claim 15, further comprising software designed to provide users access to said document repository (21), wherein completed documents are sent to predefined staff (39), assigned by job roles (100), keeping information with the job type and wherein documents types are assigned feedback times, during which a responsible party must respond, and the system will alert the next level of responsibility to respond if the first level is unable to respond.

23. The system of claim 15, further comprising said database(s) (85, 92, 97) or an additional database storing information comprising a legacy of information stored around an employee's role such that the information remains stored and accessible to any individual assigned to said role (100).

24. The system of claim 15, further comprising said database(s) (85, 92, 97) or an additional database storing information comprising information on human capital (95), competencies, organizational diplomacy, deployment and manipulation, organization, planning, pay increases, staffing models, performance analysis, organizational development, scheduling (18), trouble shooting, leadership training, performance evaluations, compliance training, training and education (31), individual development planning, building morale, fulfilling the company mission, diversity, strategic communications, bios of personnel, policies and performance objectives (96).

25. The system of claim 15, further comprising software designed to allow users access to communications in various forms, including e-mail (27), digital (99), voice and video (13), to specific individual(s) or role(s) which can be launched directly from organizational charts (1) and from scheduling modules (18).

26. The system of claim 15, further comprising a software platform that allows for customizability and expandability to client needs, as well as continuous support wherein the system is supported by staff and consultants to provide best practices, updates, education and training (31) continually and automatically, as well as upon request.

27. The system of claim 15, further comprising software gamification strategies for employment engagement to accomplish continuous process and workflow improvement, wherein through SQUEEZE™ (21) users become contributors while becoming experts by accumulating points within the categories of Safety (22), Quality (23), Effectiveness (24), Efficiency (25), and Satisfaction or Zest (26), such that user contributions will be seen by all, users receive merits (88) for using documents such that merits (88) can amount to rewards from employers and/or the company supplying software, and providing a means through which bonuses, raises and rewards can be integrated into virtual dashboards (1) and managed.

28. A method of creating a virtual business plan comprising:
(a) receiving, by one or more computing devices (83), specifically adapted business plan guidelines and advice in the form of tasks, time lines, information and resources integrated into interactive dashboards (1) and organizational charts (3),
(b) storing virtual business plan information received by said computing device(s) (83) in a database, which users can access through a web based server (84) product that arrogates organizational information and allows users to access information based on business functions, operations (94) and trainings (31),
(c) prioritizing business plan guidelines and resources in timelines so users receive most critical information first,
(d) prompting users sequentially through the steps needed to build a business plan, by following dashboards (1) and organizational charts (3), and
(f) providing users access to communicate and transmit essential business plan data with one another through the server (84) on said computing device(s) (83).
